(19) United States
(12) Patent Application Publication
(10) Pub. No.: US 2007/0175907 A1
(43) Pub. Date: Aug. 2, 2007

(54) CASING FOR A HOUSEHOLD APPLIANCE WITH NOISE INSULATION

(75) Inventors: Joerg Kempe, Guetersloh (DE); Andreas Landeck, Guetersloh (DE); Georg Nagel, Ennigerloh (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 11/668,547

(22) Filed: Jan. 30, 2007

(30) Foreign Application Priority Data
Jan. 30, 2006 (DE) 10 2006 004 349.9

(51) Int. Cl. D06F 37/00; B08B 3/00; D06F 39/00; F26B 25/06; B65D 1/42

(52) U.S. Cl. 220/639; 68/3 R; 68/235 R; 134/58 D; 34/201

(57) ABSTRACT

A housing for a household appliance includes a bottom part, a support frame including a supporting bar, and a sheet-metal panel forming a wall. The wall is attached to the support frame. A sound insulation element is provided between the supporting bar and an inner side of the sheet-metal panel. The sound insulation element includes an elastic material having substantially a form of an elastic bead.

Priority is claimed to German patent application DE 10 2006 004 349.9, filed Jan. 30, 2006, which is hereby incorporated by reference herein.

The present invention relates to a household appliance, such as a washing machine, a laundry dryer, a dishwasher, or the like, whose housing includes a support frame which is formed by supporting bars and to which are attached side walls in the form of sheet-metal panels, means for sound insulation being provided between the supporting bar and the sheet-metal panel.

### BACKGROUND

A housing design is described in EP 0 943 721 A1, for example, for laundry appliances or washing machines. Since the side walls of this washing machine have poor load-bearing properties and are therefore flexible in construction, their acoustic vibrations are restrained only to a small extent by the attachment to the base frame. Therefore, when striking the walls with the hand, a metallic sound is produced, which gives the user the impression of poor attachment and low stability. This can be prevented, for example, by applying a bitumen mat. The disadvantage of this approach is that bitumen mats for dampening purposes are only manufactured in thicknesses starting at about 2 mm. Therefore, it is impossible for the bitumen mats to be inserted to the outermost edge of the side walls, which constitutes the location of contact with the base frame. Thus, there is no form-locking fixing in position of the mat. For this reason, and because of its high weight, the bitumen mat must be adhesively bonded to the wall in a complex and very intense manner, because self-detachment of the bitumen mat causes it to fall into the appliance, possibly causing other components to fail. Moreover, due to the adhesive bonding, a composite of metal and bitumen is produced which is difficult to recycle. Furthermore, it is necessary to provide acoustic decoupling in the area of the lateral locations of contact of the housing wall with the base frame. This is intended to avoid rattling noises. Such decoupling can be achieved by inserting strips of foamed plastic. However, because of their thickness (3 mm), said strips produce a restoring force when the wall is pressed against the frame, thus making assembly more difficult.

It is also known to use hard papers as sound insulation elements (DE 92 01 865 U1). However, because of their high density, these materials are not suitable for acoustic decoupling. Furthermore, European Patent Application EP 1 120 487 A2, filed by the assignee of the present application, proposes to enhance sound insulation by applying a cardboard sheet to the interior side wall, said cardboard being sized to extend into the areas of attachment to the base frame. This approach has, in fact, turned out to be satisfactory in terms of sound insulation, but the additional part to be handled makes assembly quite labor-intensive. Moreover, care must be taken to protect the cardboard sheet from moisture, because it may be deformed or destroyed when frequently exposed to moisture.

### SUMMARY

It is, therefore, an object of the present invention to improve the housing of a household appliance of the type mentioned at the outset in terms of sound insulation and/or the connection of the housing parts.

The present invention provides a housing for a household appliance. The housing includes a bottom part, a support frame including at least one supporting bar, and a sheet-metal panel forming a wall. The wall is attached to the support frame. A sound insulation element is disposed between the at least one supporting bar and an inner side of the sheet-metal panel. The sound insulation element includes an elastic material having substantially a form of an elastic bead.

### BRIEF DESCRIPTION OF THE DRAWINGS

Exemplary embodiments of the present invention are shown in the drawings in a schematic way and will be described in more detail below. In the drawings,

FIG. 1 is an exploded-type of view of a housing, illustratively shown as part of a washing machine;

FIG. 2 is a view showing a detail in the region of the sheet-metal panel and the supporting bar;

FIG. 3 is a partially transparent view of the housing, looking at the support frame;

FIG. 4 is an elevation view of a sheet-metal panel, indicating a bead extending around its periphery;

FIG. 5 is a further view of the sheet-metal panel, showing a bead applied around its periphery and parallel beads provided in some regions thereof.

FIG. 6 is a view of another embodiment of the bead arrangement on a sheet-metal panel, featuring segments provided in a plurality of regions; and

FIG. 7 is a view of another embodiment of the bead arrangement on a sheet-metal panel, featuring different cross-sectional areas.

### DETAILED DESCRIPTION

One advantage that can be achieved with the present invention is that the connection of, or between, the housing parts in the contact regions is accomplished using an elastic material which is in the form of an elastic bead and can be applied mechanically, the application being performable by an automaton or robot. Furthermore, when using an elastomer as the elastic material, a sealing contact is provided between the metallic parts, creating a so-called flexible bridge between these metallic parts, said flexible bridge providing a joining effect with respect to the development of noise, said joining preventing, in particular, such development of noise. Another effect is that gaps between the housing parts, in particular between the walls and the supporting bars, are sealed, i.e., filled with elastic material, whereby noises caused by pumps or other units are prevented from escaping from the interior of the housing.

Another advantage in this context is that the material is flexible. The elastomer further has the advantage that it can initially be applied such that it is retained in position, it being possible for the bead to be fixed on the sheet-metal panel in the edge or overlap region thereof, either in some regions or around its entire periphery, prior to mounting of the sheet-metal panel, which is designed as a wall. Due to its self-adhesive property, the bead can be prefixed exactly at the locations where the joining effect will take place later on at the supporting bars. The same applies to the case where the bead is fixed on the supporting bars of the support frame, either in some regions or around the entire periphery thereof, prior to mounting of the sheet-metal panel. After the sheet-metal panel provided with the bead is attached to the support frame, the bead is deformed in cross-section, so that it forms a film-like shape within the gap when applying a high pressure.

The fixation of the bead can be accomplished in a quick and easy manner, because the bead is self-adhesive and can be fixed on the component, and at the location where it is intended to exert its function, just by being applied thereto. Conveniently, the adhesion of the bead caused by the self-adhesive property is only so strong that the bead can be easily and substantially completely removed from the sheet-metal panel or from the frame during recycling. Moreover, it is possible to apply parallel beads to the sheet-metal panel or to the supporting bar in some regions thereof, thus creating a significantly larger fixing area and/or a wider sound insulation bridge.

In one suitable embodiment, the bead has portions of different cross-sectional areas, whereby gaps of different widths between the sheet-metal panel and the supporting bar are reliably filled. In regions or portions where a larger gap is formed between the sheet-metal panel and the supporting bar, the bead has portions of larger cross-sectional area.

In an advantageous embodiment, the bead is configured such that, at least in some regions, a liquid-tight connection is provided between the supporting bar and the sheet-metal panel. It is advantageous, in particular, if at least the lower portion is made liquid-tight to prevent spillage or leakage to the outside in the event of damage to liquid-carrying parts within the housing. High protection against water damage is provided since the water leaking within the housing walls is completely collected in the bottom part, whereby a float switch disposed on the bottom part can activate a safety device, such as a pump. In a convenient embodiment, the bead can be used to provide a liquid-tight connection between the housing walls and/or to provide a seal between the housing cover and the housing walls. Using the elastic bead, gaps between the housing walls are reliably sealed, thereby protecting the interior of the housing against splash water from the outside.

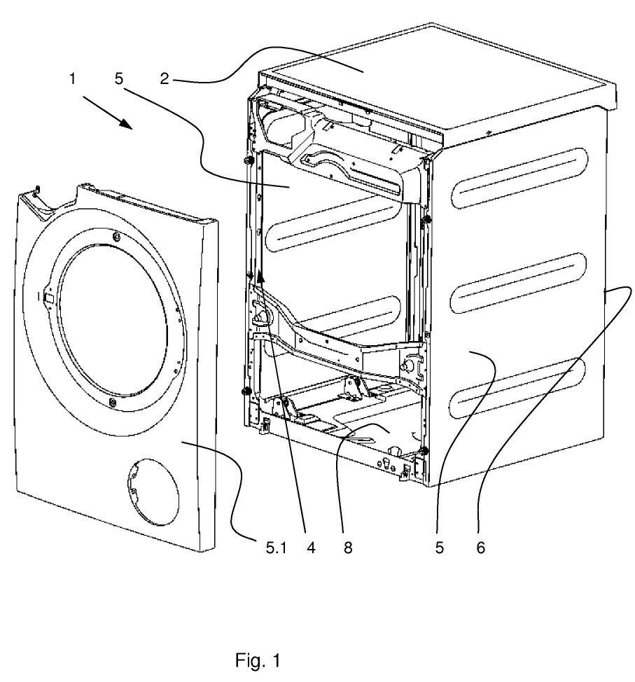

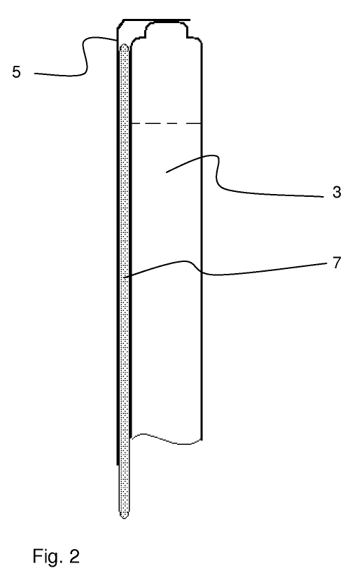

FIG. 1 illustrates, in a perspective view, a housing 1 for a household appliance, which, in the present example, is a washing machine. The housing includes a bottom part 8, a rear wall 6, a cover 2, and a support frame 4 formed by supporting bars 3, support frame 4 having attached thereto substantially vertical walls 5 in the form of sheet-metal panels, and means for sound insulation being provided in the overlap region (which can be better seen in FIG. 2) of supporting bar 3 and sheet-metal panel 5, and here between supporting bar 3 or the bottom part and sheet-metal panel 5.

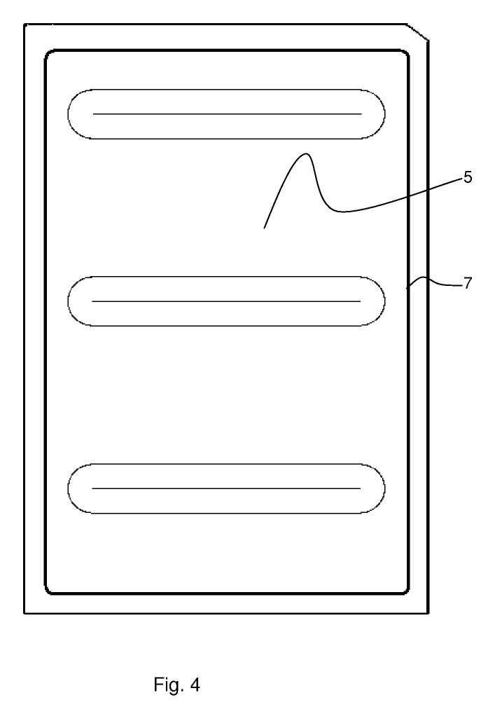

Thus, for example, the detail view of FIG. 2 shows that the means provided for sound insulation are composed of an elastomer in the form of an elastic bead 7. As illustrated in the embodiments of FIGS. 4 and 6, bead 7 can be fixed on sheet-metal panel 5 in the edge or overlap region thereof, either in some regions or around its entire periphery, prior to mounting of sheet-metal panel 5, which is designed as a side wall 5.

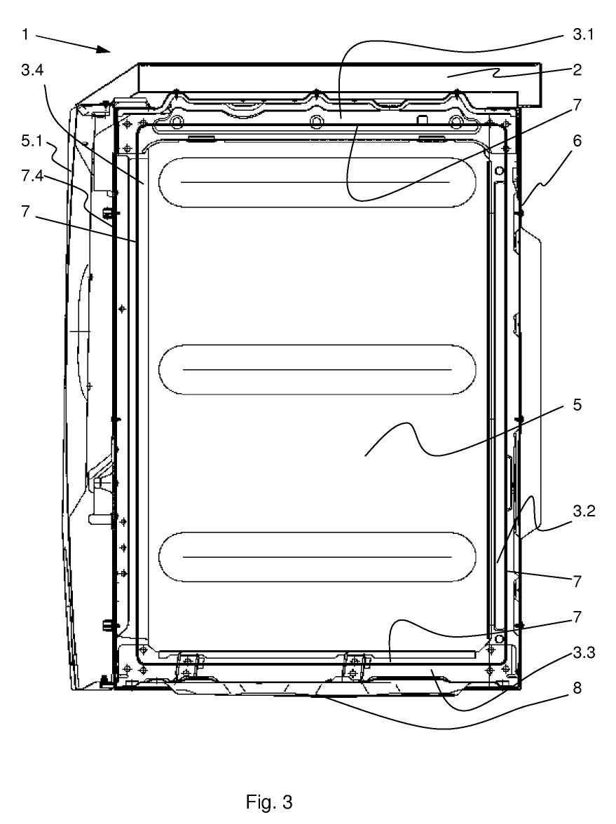

In FIG. 3, housing 1 is shown in a partially transparent side view. This view shows a substantially horizontal upper supporting bar 3.1 and a substantially vertical front supporting bar 3.4, said supporting bars, together with the upwardly directed flange 3.3 of bottom part 8 and a forwardly directed flange 3.2 of rear wall 6, forming the support frame 4 sketched in FIG. 1. In this example, the surrounding bead 7 is fixed in the edge region on sheet-metal panel 5, which is designed as a side wall, so that when sheet-metal panel 5 has been mounted, bead 7 rests on supporting bars 3.1, 3.4 and flanges 3.3 and 3.2. Bead 7 can be applied on supporting bars 3.1, 3.4 and flanges 3.3, 3.2 in some regions or around the entire periphery thereof prior to mounting of sheet-metal panel 5. The fixation of bead 7 can be done by a robot, whereupon sheet-metal panel 5 can be placed in position and fastened with screws or rivets in an easy and simple manner. Due to its self-adhesive property, bead 7 is retained in its intended position during the mounting process. An elastic bead 7.4 is also provided in the gap between the sheet-metal panel 5.1, which is designed as a front wall, and frame member 3.4 or the front flange of lateral sheet-metal panel 5. This bead 7.4 also serves to protect the interior of the housing against outside splash water.

FIG. 4 shows a sheet-metal panel 5 which is designed as a side wall and is provided on its inner side with a bead 7 around its entire periphery. The fixation of bead 7 on sheet-metal panel 5 can be produced in a particularly advantageous manner since an automaton for applying the elastic material for bead 7 has to be moved in one plane only. Since bead 7 is fixed on sheet-metal panels 5 in a self-adhesive manner, no special measures need to be taken for the handling of sheet-metal panels 5 during assembly.

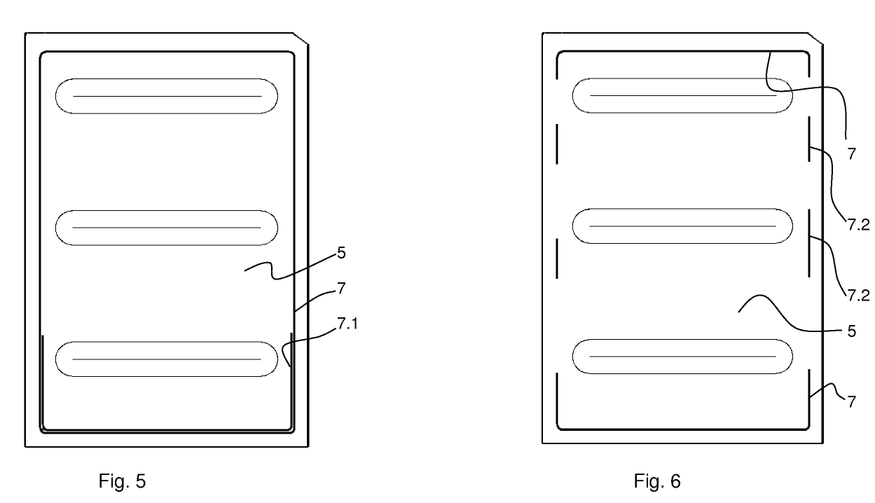

FIG. 5 shows an advantageous embodiment of the sheet-metal panel 5 which designed as a side wall, featuring a further bead 7.1 which is fixed on the inner side in addition to the bead 7 that extends around the entire periphery thereof. This makes it possible to improve the impermeability to liquids at particularly stressed locations, such as in the lower portion.

FIG. 6 shows another embodiment of the sheet-metal panel 5 which designed as a side wall, where the bead 7 provided on the inner side does not extend around the entire periphery. In this embodiment, bead segments 7.2 are fixed at locations of low stress, thereby saving material for bead 7, 7.2.

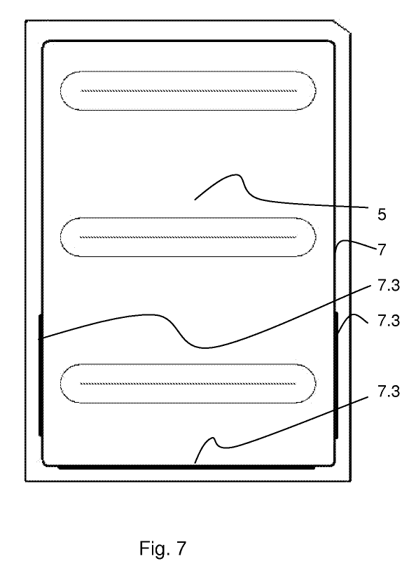

FIG. 7 shows an alternative embodiment of the sheet-metal panel 5 which designed as a side wall, where the bead 7 provided on the inner side extends around the entire periphery. In this embodiment, the surrounding bead 7 is designed to include thicker segments 7.3 at locations of higher stress and/or at locations where the gap formed with the supporting bar is larger. This allows proper adjustment of bead 7 to the accuracy of fit and the geometrical conditions of sheet-metal panels 5 with respect to support frame 4. The embodiments proposed in FIGS. 4 through 7 are also applicable to front wall 5.1 or rear wall 6, which are in the form of sheet-metal panels.

The present invention is not limited to the exemplary embodiments described herein; reference should be had to the appended claims.

What is claimed is:

1. A housing for a household appliance, the housing comprising:
a bottom part;
a support frame including at least one supporting bar;
a sheet-metal panel forming a wall, the wall being attached to the support frame; and
a sound insulation element disposed between the at least one supporting bar and an inner side of the sheet-metal panel, the sound insulation element including an elastic material having substantially a form of an elastic bead.

2. The housing as recited in claim 1 wherein the household appliance includes at least one of a washing machine, a laundry dryer, a washer-dryer machine and a dishwasher.

3. The housing as recited in claim 1 wherein the bead is fixed on the at least one supporting bar in at least one region of the support frame or around an entire periphery thereof.

4. The housing as recited in claim 1 wherein the bead is fixed on the sheet-metal panel in an edge region thereof in at least one region of the sheet-metal panel or around an entire periphery thereof.

5. The housing as recited in claim 3 wherein the bead is fixed around an entire periphery of the sheet-metal panel, and wherein the sound insulation element includes a second elastic bead extending in parallel to the bead in at least one region thereof.

6. The housing as recited in claim 4 wherein the bead is fixed around an entire periphery of the sheet-metal panel, and wherein the sound insulation element includes a second elastic bead extending in parallel to the bead in at least one region thereof.

7. The housing as recited in claim 3 wherein the bead includes a first and a second portion, the first portion having a larger cross-sectional area than a cross-sectional area of the second portion.

8. The housing as recited in claim 4 wherein the bead includes a first and a second portion, the first portion having a larger cross-sectional area than a cross-sectional area of the second portion.

9. The housing as recited in claim 5 wherein the bead includes a first and a second portion, the first portion having a larger cross-sectional area than a cross-sectional area of the second portion.

10. The housing as recited in claim 6 wherein the bead includes a first and a second portion, the first portion having a larger cross-sectional area than a cross-sectional area of the second portion.

11. The housing as recited in claim 1 wherein the bead is disposed on at least one of the sheet-metal panel and the at least one supporting bar in a self-adhesive manner.

12. The housing as recited in claim 1 wherein the bead is configured, in at least a first region thereof, to provide a liquid-tight connection between the sheet-metal panel and the at least one supporting bar.
